(19) United States
(12) Patent Application Publication
(10) Pub. No.: US 2023/0115207 A1
(43) Pub. Date: Apr. 13, 2023

(54) Fish robot

(71) Applicant: Artificial Intelligence Robot INC., Gwangmyeong-si (KR)

(72) Inventors: Kyong Chol CHONG, Suncheon-si (KR); Yong Joo OH, Suwon-si (KR); Hyo Gi SEO, Gwangju (KR); Su San PARK, Gwangmyeong-si (KR); Hong Sik YANG, Gwangmyeong-si (KR)

(21) Appl. No.: 17/936,772

(22) Filed: Sep. 29, 2022

(30) Foreign Application Priority Data
Sep. 29, 2021 (KR) 10-2021-0128611

(51) Int. Cl. B63G 8/08; B63G 8/00

(52) U.S. Cl. CPC B63G 8/08; B63G 8/001; B63G 2008/002

(57) ABSTRACT

The present invention relates to a robotic fish that is capable of swimming horizontally and vertically. According to the present invention, the robotic fish includes: a cylinder joint part for performing piston movements to allow the robotic fish to swim under water; and a controller for controlling the cylinder joint part.

### FIELD OF THE INVENTION

The present invention relates to a robotic fish, and more specifically, to a robotic fish that is capable of swimming horizontally and vertically.

### BACKGROUND OF THE RELATED ART

A conventional multi-joint robotic fish has the shape as shown in FIGS. 1 and 2. FIG. 1 is a side view showing a conventional two-joint robotic fish, and FIG. 2 is a plan view showing the robotic fish of FIG. 1.

To allow the robotic fish as shown in FIGS. 1 and 2 to move forward, its bodies 1, 2 and 3 swing in left and right directions using joints 4 and 5 disposed thereamong to obtain a forward propelling force from a resistance force occurring in the opposite direction to the direction of pushing water backward. In FIGS. 1 and 2, a reference numeral 6 not explained yet represents a dorsal fin, a reference numeral 7 represents a pectoral fin, and a reference numeral 8 represents a caudal fin.

Further, in a state where the conventional robotic fish has front and back balancing in a horizontal direction of water, as shown in FIG. 3A, if a battery block 9 located inside the first body 1 moves backward, as shown in FIG. 3B, the head of the robotic fish moves upward so that the robotic fish can swim upward. Contrarily, if the battery block 9 moves forward, as shown in FIG. 3C, the head of the robotic fish moves downward so that the robotic fish can swim downward.

### PRIOR ART LITERATURE

Patent document 1: Korean Patent No. 10-1094789 entitled “Robotic fish and method for swimming same”
Patent document 2: Korean Patent Application Laid-open No. 10-2012-0138295 entitled “Method for controlling swimming of robotic fish”

### SUMMARY OF THE INVENTION

Accordingly, the present invention has been made in view of the above-mentioned problems occurring in the related art, and it is an object of the present invention to provide a robotic fish that is configured to have cylinder type joints so that the robotic fish can swim horizontally and vertically.

To accomplish the above-mentioned objects, according to the present invention, there is provided a robotic fish including: a cylinder joint part for performing piston movements to allow the robotic fish to swim under water; and a controller for controlling the cylinder joint part.

According to the present invention, desirably, the cylinder joint part may include a plurality of cylinders adapted to individually operate under the control of the controller to allow the robotic fish to swim under water.

According to the present invention, desirably, each cylinder may be a hydraulic or pneumatic cylinder.

According to the present invention, desirably, the controller may control the cylinder joint part to allow the robotic fish to swim in an upward direction, in a downward direction, in a left direction, in a right direction, in upward and downward directions, and in left and right directions.

According to the present invention, desirably, the cylinder joint part may include: a plurality of partition walls spaced apart from one another; the plurality of cylinders disposed spaced apart from one another on each partition wall; and joints disposed between the neighboring partition walls to connect the neighboring partition walls to each other.

According to the present invention, desirably, the plurality of partition walls may be arranged sequentially in a longitudinal direction of a body of the robotic fish, while being spaced apart from one another at given intervals.

According to the present invention, desirably, two of the plurality of cylinders may be located on an upper portion of the corresponding partition wall and the remaining two may be on a lower portion of the corresponding partition wall. In this case, the first and second cylinders of the plurality of cylinders may be disposed spaced apart from each other on the upper portion of the corresponding partition wall, and the third and fourth cylinders may be disposed spaced apart from each other on the lower portion of the corresponding partition wall.

According to the present invention, desirably, a first distance between the first and second cylinders may be equal to a second distance between the third and fourth cylinders, and a third distance between the first and third cylinders may be equal to a fourth distance between the second and fourth cylinders.

According to the present invention, desirably, the controller may move the first and second cylinders outward and the third and fourth cylinders inward so as to allow the robotic fish to swim in the upward direction.

According to the present invention, desirably, the controller may move the first and second cylinders inward and the third and fourth cylinders outward so as to allow the robotic fish to swim in the downward direction.

According to the present invention, desirably, the controller may alternately perform a first control operation in which the first and second cylinders move outward and the third and fourth cylinders move inward and a second control operation in which the first and second cylinders move inward and the third and fourth cylinders move outward so as to allow the robotic fish to swim in the upward and downward directions.

According to the present invention, desirably, the controller may move the first and third cylinders outward and the second and fourth cylinders inward so as to allow the robotic fish to swim in the left direction.

According to the present invention, desirably, the controller may move the first and third cylinders inward and the second and fourth cylinders outward so as to allow the robotic fish to swim in the right direction.

According to the present invention, desirably, the controller may alternately perform a third control operation in which the first and third cylinders move outward and the second and fourth cylinders move inward and a fourth control operation in which the first and third cylinders move inward and the second and fourth cylinders move outward so as to allow the robotic fish to swim in the left and right directions.

### BRIEF DESCRIPTION OF THE DRAWINGS

The above and other objects, features and advantages of the present invention will be apparent from the following detailed description of the embodiments of the invention in conjunction with the accompanying drawings, in which:

FIG. 1 is a side view showing a conventional two-joint robotic fish;

FIG. 2 is a plan view showing the conventional two-joint robotic fish of FIG. 1;

FIG. 3 are side views showing a swimming propelling principle of the conventional two-joint robotic fish;

FIG. 4 is a side view showing an internal configuration of a robotic fish according to the present invention;

FIG. 5 is an enlarged view showing a cylinder joint part of FIG. 4;

FIG. 6 is a side view showing a portion of the cylinder joint part of FIG. 4 on the right side; and

FIGS. 7 and 8 are side views showing operations of the robotic fish according to the present invention.

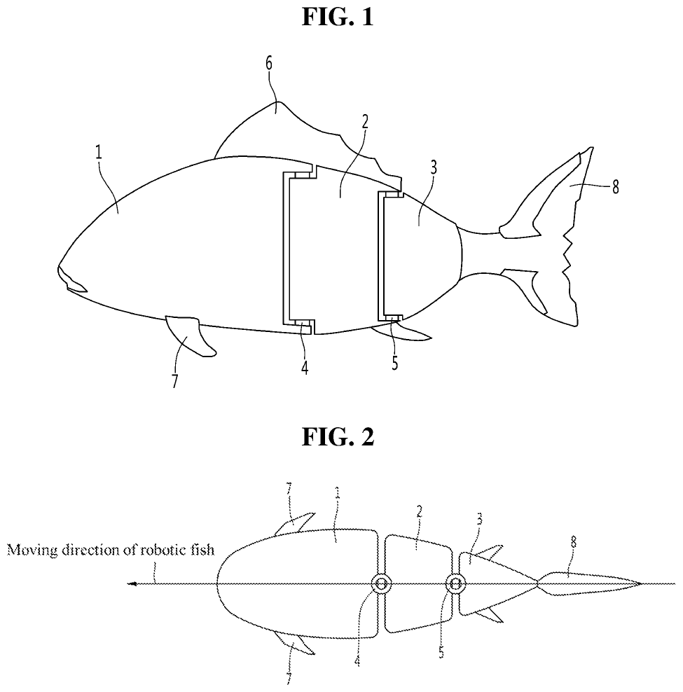

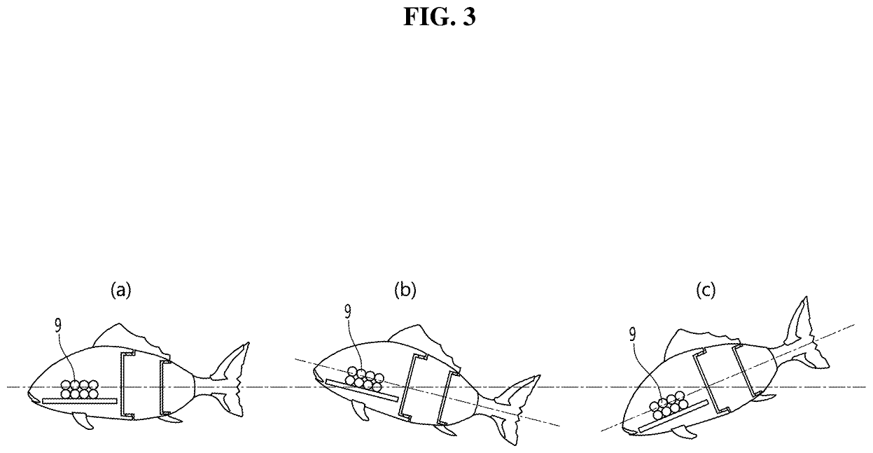

### DETAILED DESCRIPTION OF THE EMBODIMENTS

The present invention may be modified in various ways and may have several exemplary embodiments. Specific exemplary embodiments of the present invention are illustrated in the drawings and described in detail in the detailed description.

However, this does not limit the invention within specific embodiments and it should be understood that the invention covers all the modifications, equivalents, and replacements within the idea and technical scope of the invention.

Terms used in this application are used to only describe specific exemplary embodiments and are not intended to restrict the present invention. An expression referencing a singular value additionally refers to a corresponding expression of the plural number, unless explicitly limited otherwise by the context. In this application, terms, such as “comprise”, “include”, or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

The present invention is disclosed with reference to the attached drawings wherein the corresponding parts in the embodiments of the present invention are indicated by corresponding reference numerals and the repeated explanation on the corresponding parts will be avoided.

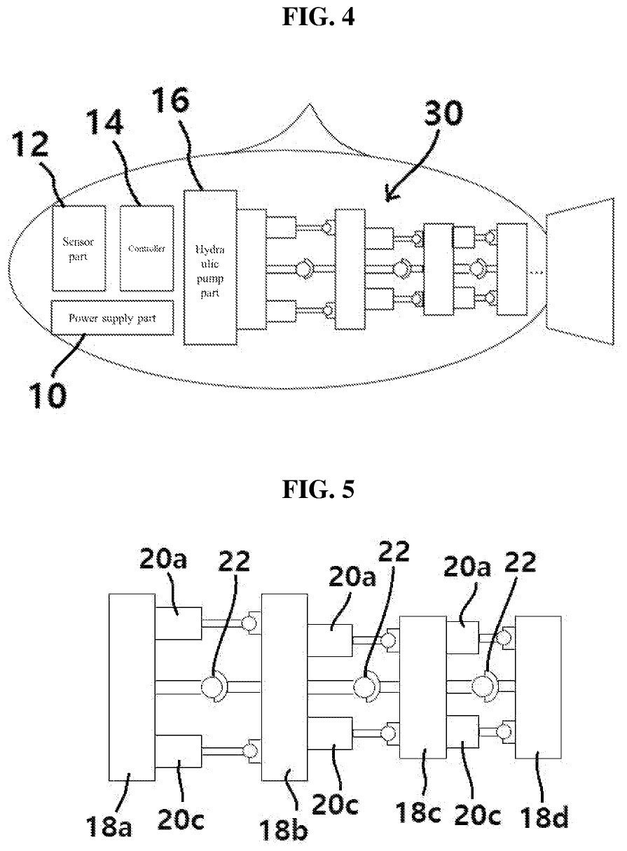

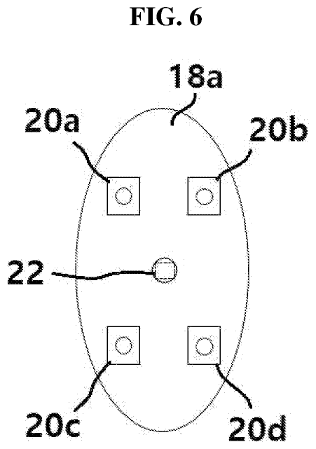

FIG. 4 is a side view showing an internal configuration of a robotic fish according to the present invention, FIG. 5 is an enlarged view showing a cylinder joint part of FIG. 4, and FIG. 6 is a side view showing a portion of the cylinder joint part of FIG. 4 on the right side.

The robotic fish according to the present invention is a robotic fish having the shape of a living fish so that it is capable of horizontally and vertically swimming under water, while being submerged in water or floating on water.

The robotic fish according to the present invention may have various shapes.

The robotic fish according to the present invention has the head, mouth, and gill located on a front body portion.

The robotic fish according to the present invention includes a power supply part 10, a sensor part 12, a controller 14, a hydraulic pump part 16, and a cylinder joint part 30.

The power supply part 10 supplies power for operating the corresponding robotic fish.

The power supply part 10 may include a given number of batteries.

The sensor part 12 is disposed on the front body portion to sense obstacles existing around the robotic fish swimming.

For example, the sensor part 12 may include an obstacle detection sensor part with left and right sensors, a front sensor, and an underside sensor.

Of course, the sensor part 12 can detect a given distance from a floor.

If necessary, the sensor part 12 may further include a water pressure detection sensor for sensing a water pressure and an inclination detection sensor for detecting inclinations of the head and tail of the corresponding robotic fish.

The controller 14 controls the general operations of the robotic fish according to the present invention.

That is, the controller 14 controls the horizontal and vertical swimming of the robotic fish according to the present invention.

In specific, the controller 14 controls operations of the hydraulic pump part 16 so as to allow the robotic fish according to the present invention to be horizontally and vertically swimmable.

Of course, the controller 14 allows the robotic fish to be horizontally and vertically swimmable, while avoiding an obstacle, based on the sensed signal from the sensor part 12.

The hydraulic pump part 16 operates the cylinder joint part 30 under the control of the controller 14.

That is, the hydraulic pump part 16 performs a pumping operation under the control of the controller 14 to thus operate the cylinder joint part 30.

For example, the hydraulic pump part 16 may include a plurality of hydraulic pumps spaced apart from one another. In this case, pumping degrees of the respective hydraulic pumps are controlled by the controller 14.

The cylinder joint part 30 is disposed inside the body of the robotic fish according to the present invention and serves as joints.

In specific, the cylinder joint part 30 is connected to the hydraulic pump part 16 and performs piston movements based on the pumping operations of the hydraulic pump part 16.

As shown in FIGS. 5 and 6, the cylinder joint part 30 includes a plurality of partition walls 18a, 18b, 18c, and 18d spaced apart from one another, a plurality of cylinders 20a, 20b, 20c, and 20d disposed spaced apart from one another on each partition wall, and joints 22 disposed between the neighboring partition walls to connect the neighboring partition walls to one another.

The plurality of partition walls 18a, 18b, 18c, and 18d are arranged sequentially in a longitudinal direction of the body of the robotic fish according to the present invention, while being spaced apart from one another at given intervals.

Two of the plurality of cylinders 20a, 20b, 20c, and 20d are located on an upper portion of the corresponding partition wall and the remaining two are on a lower portion of the corresponding partition wall.

In specific, the cylinders 20a and 20b are disposed spaced apart from each other on the upper portion of the corresponding partition wall, and the cylinders 20c and 20d are disposed spaced apart from each other on the lower portion of the corresponding partition wall.

Desirably, a distance between the cylinders 20a and 20b is equal to a distance between the cylinders 20c and 20d, and a distance between the cylinders 20a and 20c is equal to a distance between the cylinders 20b and 20d. This enables the robotic fish to horizontally and vertically swim gently, without having any problems in the operations of the cylinders 20a, 20b, 20c, and 20d.

In this case, the distance between the cylinders 20a and 20b may be defined as a first distance, the distance between the cylinders 20c and 20d as a second distance, the distance between the cylinders 20a and 20c as a third distance, and the distance between the cylinders 20b and 20d as a fourth distance.

The plurality of partition walls 18a, 18b, 18c, and 18d serve to support the cylinders 20a, 20b, 20c, and 20d thereagainst, and therefore, they are called support walls.

In this case, the cylinder 20a may be defined as a first cylinder, the cylinder 20b as a second cylinder, the cylinder 20c as a third cylinder, and the cylinder 20d as a fourth cylinder.

The joints 22 are disposed on the centers of the neighboring partition walls 18a, 18b, 18c, and 18d to connect the neighboring partition walls 18a, 18b, 18c, and 18d to one another, while being disposed spaced apart from the cylinders 20a, 20b, 20c, and 20d.

For example, in the case of the joint 22 between the partition walls 18a and 18b, one end of the joint 22 is connected to the partition wall 18a, and the other end is connected to the partition wall 18b.

Accordingly, the joint 22 between the partition walls 18b and 18c and the joint 22 between the partition walls 18c and 18d are disposed in the same manner as above.

For example, the joints 22 may be formed of ball joints, but even though they can transfer power, they may be free in shape.

The cylinder joint part 30 includes the cylinders 20a, 20b, 20c, and 20d and thus serves as joints.

In FIG. 4, the hydraulic pump part 16 has been shown, and accordingly, the cylinders 20a, 20b, 20c, and 20d are desirably hydraulic cylinders.

In specific, the hydraulic pump part 16 operates the cylinders 20a, 20b, 20c, and 20d disposed on each of the partition walls 18a, 18b, 18c, and 18d under the control of the controller 14.

In FIG. 5, only four partition walls are shown, but four or more partition walls or four or less partition walls may be disposed.

In FIG. 5, further, a configuration between the partition walls 18a and 18b may be defined as a first cylinder joint, a configuration between the partition walls 18b and 18c as a second cylinder joint, and a configuration between the partition walls 18c and 18d as a third cylinder joint.

In FIG. 4, blocks by function are shown to allow the present invention to be understood well, but if necessary, the hydraulic pump part 16 may be included in the controller 14.

In FIG. 4, meanwhile, the hydraulic pump part 16 is shown, but if necessary, it may be replaced with a pneumatic pump part. If so, the cylinders 20a, 20b, 20c, and 20d of the cylinder joint part 30 may be pneumatic cylinders.

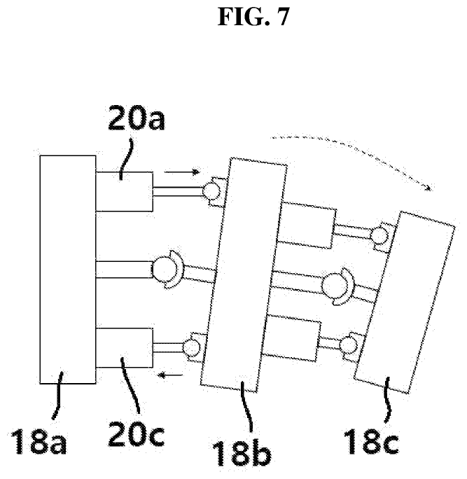

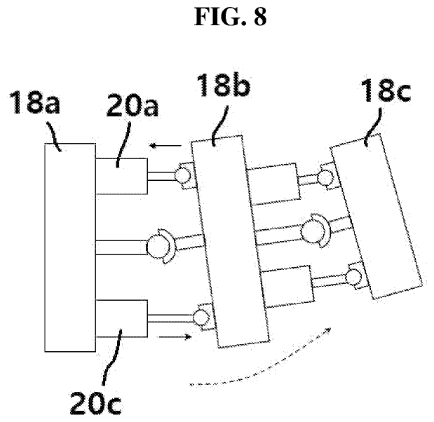

FIGS. 7 and 8 are side views showing operations of the robotic fish according to the present invention.

The robotic fish according to the present invention is configured to operate the four cylinders 20a, 20b, 20c, and 20d appropriately with respect to each joint 22 disposed between the neighboring partition walls, so that it can swim in different forms.

So as to allow the robotic fish to swim upward, for example, the controller 14 operates the hydraulic pump part 16 to allow the cylinders 20a and 20b between the neighboring partition walls 18a, 18b, 18c, and 18d to move outward and to allow the cylinders 20c and 20d to move inward. As a result, the four cylinders 20a, 20b, 20c, and 20d operate as shown in FIG. 7.

According to the present invention, the outward movements of the cylinders are performed when the pistons (not shown) in the cylinders move linearly to allow piston rods (not shown) to move forward by a given distance. Further, the inward movements of the cylinders are performed when the pistons in the cylinders move linearly to allow the piston rods to move backward by a given distance.

If the four cylinders 20a, 20b, 20c, and 20d operate as shown in FIG. 7, like this, the robotic fish swims upward. In this case, degrees of inward movements (backward movements of the piston rods) and degrees of outward movements (forward movements of the piston rods) of the four cylinders 20a, 20b, 20c, and 20d are controllable freely by the controller 14.

So as to allow the robotic fish to swim downward, for another example, the controller 14 operates the hydraulic pump part 16 to allow the cylinders 20a and 20b between the neighboring partition walls 18a, 18b, 18c, and 18d to move inward and to allow the cylinders 20c and 20d to move outward. As a result, the four cylinders 20a, 20b, 20c, and 20d operate as shown in FIG. 8.

If the four cylinders 20a, 20b, 20c, and 20d operate as shown in FIG. 8, like this, the robotic fish swims downward. In this case, degrees of inward movements (backward movements of the piston rods) and degrees of outward movements (forward movements of the piston rods) of the four cylinders 20a, 20b, 20c, and 20d are controllable freely by the controller 14.

If necessary, the operations of the cylinders 20a, 20b, 20c, and 20d as shown in FIG. 7 and the operations of the cylinders 20a, 20b, 20c, and 20d as shown in FIG. 8 may be performed alternately. That is, the upward and downward swimming of the robotic fish can be performed when the operations of the cylinders 20a, 20b, 20c, and 20d as shown in FIG. 7 and the operations of the cylinders 20a, 20b, 20c, and 20d as shown in FIG. 8 are performed alternately. So as to allow the robotic fish to swim upward and downward, in specific, the controller 14 alternately performs a first control operation in which the cylinders 20a and 20b move outward and the cylinders 20c and 20d move inward and a second control operation in which the cylinders 20a and 20b move inward and the cylinders 20c and 20d move outward.

So as to allow the robotic fish to swim in a left or right direction, further, the cylinders 20a, 20b, 20c, and 20d have to operate differently from the operations as shown in FIGS. 7 and 8.

So as to allow the robotic fish to swim in a left direction, for example, the controller 14 operates the hydraulic pump part 16 to allow the cylinders 20a and 20c between the neighboring partition walls 18a, 18b, 18c, and 18d to move outward and to allow the cylinders 20b and 20d to move inward. As a result, the robotic fish can swim in the left direction. In this case, degrees of inward movements (backward movements of the piston rods) and degrees of outward movements (forward movements of the piston rods) of the four cylinders 20a, 20b, 20c, and 20d are controllable freely by the controller 14.

So as to allow the robotic fish to swim in a right direction, for another example, the controller 14 operates the hydraulic pump part 16 to allow the cylinders 20a and 20c between the neighboring partition walls 18a, 18b, 18c, and 18d to move inward and to allow the cylinders 20b and 20d to move outward. As a result, the robotic fish can swim in the right direction. In this case, degrees of inward movements (backward movements of the piston rods) and degrees of outward movements (forward movements of the piston rods) of the four cylinders 20a, 20b, 20c, and 20d are controllable freely by the controller 14.

If necessary, the swimming operations in the left direction and the swimming operations in the right direction may be performed alternately. That is, the left and right swimming of the robotic fish can be performed when the swimming operations in the left direction and the swimming operations in the right direction are performed alternately. So as to allow the robotic fish to swim in the left and right directions, in specific, the controller 14 alternately performs a third control operation in which the cylinders 20a and 20c move outward and the cylinders 20b and 20d move inward and a fourth control operation in which the cylinders 20a and 20c move inward and the cylinders 20b and 20d move outward.

As described above, the robotic fish according to the present invention is configured to have the cylinder type joints so that it can swim horizontally and vertically.

In specific, the robotic fish according to the present invention is configured to operate the four cylinders appropriately with respect to each joint between the neighboring partition walls, so that it can swim in different forms.

The present invention may be modified in various ways and may have several exemplary embodiments. Accordingly, it should be understood that the invention covers all the modifications, equivalents, and replacements within the idea and technical scope of the invention. Therefore, the present invention is not to be restricted by the embodiments as mentioned above. It is therefore intended that the scope of the invention be limited not by this detailed description, but rather by the claims appended hereto.

What is claimed is:

1. A robotic fish comprising:
a cylinder joint part performing piston movements to allow the robotic fish to swim under water; and
a controller controlling the cylinder joint part.

2. The robotic fish according to claim 1, wherein the cylinder joint part comprises a plurality of cylinders adapted to individually operate under the control of the controller to allow the robotic fish to swim under water.

3. The robotic fish according to claim 2, wherein each cylinder is a hydraulic or pneumatic cylinder.

4. The robotic fish according to claim 1, wherein the controller controls the cylinder joint part to allow the robotic fish to swim in an upward direction, in a downward direction, in a left direction, in a right direction, in upward and downward directions, and in left and right directions.

5. The robotic fish according to claim 1, wherein the cylinder joint part comprises:
a plurality of partition walls spaced apart from one another;
the plurality of cylinders disposed spaced apart from one another on each partition wall; and
single joints disposed between the neighboring partition walls to connect the neighboring partition walls to each other.

6. The robotic fish according to claim 5, wherein the plurality of partition walls are arranged sequentially in a longitudinal direction of a body of the robotic fish, while being spaced apart from one another at given intervals.

7. The robotic fish according to claim 5, wherein two of the plurality of cylinders are located on an upper portion of the corresponding partition wall and the remaining two are on a lower portion of the corresponding partition wall.

8. The robotic fish according to claim 7, wherein the first and second cylinders of the plurality of cylinders are disposed spaced apart from each other on the upper portion of the corresponding partition wall, and the third and fourth cylinders are disposed spaced apart from each other on the lower portion of the corresponding partition wall.

9. The robotic fish according to claim 8, wherein a first distance between the first and second cylinders is equal to a second distance between the third and fourth cylinders, and a third distance between the first and third cylinders is equal to a fourth distance between the second and fourth cylinders.

10. The robotic fish according to claim 8, wherein the controller moves the first and second cylinders outward and the third and fourth cylinders inward so as to allow the robotic fish to swim in the upward direction.

11. The robotic fish according to claim 8, wherein the controller moves the first and second cylinders inward and the third and fourth cylinders outward so as to allow the robotic fish to swim in the downward direction.

12. The robotic fish according to claim 8, wherein the controller alternately performs a first control operation in which the first and second cylinders move outward and the third and fourth cylinders move inward and a second control operation in which the first and second cylinders move inward and the third and fourth cylinders move outward so as to allow the robotic fish to swim in the upward and downward directions.

13. The robotic fish according to claim 8, wherein the controller moves the first and third cylinders outward and the second and fourth cylinders inward so as to allow the robotic fish to swim in the left direction.

14. The robotic fish according to claim 8, wherein the controller moves the first and third cylinders inward and the second and fourth cylinders outward so as to allow the robotic fish to swim in the right direction.

15. The robotic fish according to claim 8, wherein the controller alternately performs a third control operation in which the first and third cylinders move outward and the second and fourth cylinders move inward and a fourth control operation in which the first and third cylinders move inward and the second and fourth cylinders move outward so as to allow the robotic fish to swim in the left and right directions.
